(19) United States
(12) Patent Application Publication
(10) Pub. No.: US 2026/0181335 A1
(43) Pub. Date: Jun. 25, 2026

(54) DETECTION OF A HEARING DEVICE STATE

(71) Applicant: GN Hearing A/S, Ballerup (DK)

(72) Inventors: Christian Køcks LYKKEGAARD, Vaerloese (DK); Johnny FREDSGAARD, Frederiksberg (DK)

(73) Assignee: GN Hearing A/S, Ballerup (DK)

(21) Appl. No.: 19/421,546

(22) Filed: Dec. 16, 2025

(30) Foreign Application Priority Data
Dec. 19, 2024 (EP) 24221533

(51) Int. Cl. H04R 25/00

(52) U.S. Cl. CPC H04R 25/453; H04R 25/505

(57) ABSTRACT

Disclosed is a hearing device comprising an input transducer configured to be arranged in an ear canal of a user and to provide an input signal. The hearing device further comprises a signal processing unit configured to receive the input signal from the input transducer and to generate a processed signal. The signal processing unit comprises an adaptive feedback filter characterized by its filter coefficients. The filter coefficients are configured to change in response to changes of the input signal. The signal processing unit is configured to monitor the filter coefficients. The signal processing unit is also configured to determine a state of the hearing device based on a threshold and the filter coefficients.

### RELATED APPLICATION DATA

This application claims priority to, and the benefit of, European Patent Application No. 24221533 filed on Dec. 19, 2024. The entire disclosure of the above application is expressly incorporated by reference herein.

### FIELD

The present disclosure relates to hearing devices. More specifically, the disclosure relates to a hearing device comprising an input transducer configured to be arranged in an ear canal of a user and an adaptive feedback filter arranged in connection to said input transducer.

### BACKGROUND

Hearing devices, including hearing aids, earbuds, hearing protection devices, augmented audio devices, etc. are designed to enhance auditory perception and provide users with a seamless hearing experience. These devices often incorporate one or more microphones, and in particular in-ear microphones, to capture ambient sounds and sounds closer to the eardrum, which are then processed, amplified, and delivered to the user's ear.

One persistent challenge in hearing devices with in-ear microphones is acoustic feedback, commonly experienced as a high-pitched squeal. Due to the proximity of the in-ear microphone to the receiver and the confined acoustics of the ear canal, feedback occurs when amplified sound from the speaker re-enters the microphone, creating a feedback loop. The problem is particularly noticeable during transitions, such as inserting the device into the ear, removing it from the ear, or placing it into a charging dock.

Existing methods for mitigating feedback include various algorithms, accelerometers, and tone generation. These methods either have high computational cost or require additional components to be included in an already tightly packed hearing device.

Therefore, there is a need for an alternative solution to reduce undesired feedback squealing in hearing devices with in-ear microphones, particularly during transitions or dynamic states and a solution which overcomes the issues of the current solutions.

### SUMMARY

At present, there are no simple methods for identifying whether a hearing device is being removed from the user's ear or whether it is placed in a charger or removed therefrom. It is thus an object of the present disclosure to provide a simple way of determining whether the hearing device is being removed from the user's ear, as well as whether it has been placed into the ear. Similarly, it is an object to provide a simple way of determining whether the hearing device is placed/removed into/from the charger.

It is a further object to prevent unnecessary operation of the hearing device in cases when the hearing device is outside of the user's ear or when the hearing device is in the charger, but the user forgets to turn it off.

It is a further object of the embodiments to prevent feedback squealing occurring during reinsertions of the hearing device with an in-the-ear microphone into the user's ear.

It is a further object of the embodiments to prevent feedback squealing occurring when the hearing device is booting in a charger.

It is yet further object of the embodiments to prevent faulty adaption of an adaptive algorithm when the hearing device is removed from the ear/charger.

It is also an object of the embodiments to provide a solution which does not have high-computational cost, and which does not require additional components other than those which are already implemented in the hearing device

To achieve the above-mentioned objects, disclosed is a hearing device comprising an input transducer configured to be arranged in an ear canal of a user and to provide an input signal. The hearing device further comprises a signal processing unit configured to receive the input signal from the input transducer and to generate a processed signal. The signal processing unit comprises an adaptive feedback filter characterized by its filter coefficients. The filter coefficients are configured to change in response to changes of the input signal. The signal processing unit is configured to monitor the filter coefficients. The signal processing unit is also configured to determine a state of the hearing device based on a threshold and the filter coefficients.

The hearing device of the present disclosure is an audio device typically configured to be worn in, on, over and/or at the user's ear. At least a part of the hearing device is configured to be arranged at the user's ear, on the user's ear, over the user's ear, in the user's ear, in the user's ear canal, behind the user's ear and/or in the user's concha. The hearing device may be a device configured for communication with one or more other devices, such as configured for communication with another hearing device or with an accessory device or with a peripheral device. The user may wear two hearing devices, one hearing device at each ear. The two hearing devices may be connected, such as wirelessly connected and/or connected by wires, such as a binaural hearing device system comprising a first and second hearing device.

The hearing device may be configured for audio communication, e.g. enabling the user to listen to media, such as music or radio, and/or enabling the user to perform phone calls. The hearing device may be configured for performing noise cancellation.

The hearing device may be a hearable such as a headset, headphone, earphone, earbud, hearing aid, a personal sound amplification product (PSAP), an over-the-counter (OTC) hearing device, an augmented audio device, a hearing protection device, a one-size-fits-all hearing device, a custom hearing device or another head-wearable hearing device. Hearing devices can include both prescription devices and non-prescription devices. The hearing device may be on the ear headphones or over the ear headphones. The person skilled in the art is well aware of different kinds of hearing devices and of different options for arranging the hearing device in, on, over and/or at the ear of the hearing aid wearer. The hearing device (or pair of hearing devices) may be custom fitted, standard fitted, open fitted and/or occlusive fitted.

The hearing device of the present disclosure comprises at least one input transducer configured to be arranged in the ear canal of the user, when the hearing device is in use. The input transducer may comprise one or more microphones. The input transducer may comprise one or more vibration sensors configured for detecting bone vibration. In the present application, this input transducer may be referred as a microphone in the ear (MIE). Typically, MIE is adapted to be located in a predefined position in the ear when the hearing device is in use. The signal processing unit may be pre-set to operate in accordance with this predefined position when the hearing device is in use. There may be more than one MIE in one hearing device. Also, the hearing device may comprise other input transducers which may be arranged in the hearing device but not necessarily to be provided in the ear canal. One or more input transducer(s) may be configured for converting an acoustic signal into a first electric input signal. The first electric input signal may be an analogue signal. The first electric input signal may be a digital signal. The one or more input transducer(s) may be coupled to one or more analogue-to-digital converter(s) configured for converting the analogue first input signal into a digital first input signal. MIE provides the input signal to the signal processing unit (SPU), the input signal being an electric signal representing an acoustic signal received by MIE.

The hearing device may comprise an outer input transducer, e.g. a microphone, or an analogue-to-digital converter, to generate one or more microphone output signals based on a received audio signal. The audio signal may be an analogue signal. Thus, the outer input transducer may convert the analogue audio signal into a digital microphone output signal. All the signals may be sound signals or signals comprising information about sound.

The SPU may be configured for processing the first and/or second electric input signal(s). The processing may comprise performing feedback cancelation, beamforming, tinnitus reduction/masking, noise reduction, noise cancellation, speech recognition, bass adjustment, treble adjustment and/or processing of user input. The SPU may be a processor, an integrated circuit, an application, functional module, etc. The SPU may be implemented in a signal-processing chip or a printed circuit board (PCB). The SPU may comprise compensating for a hearing loss of the user, i.e., apply frequency dependent gain to input signals in accordance with the user's frequency dependent hearing impairment. The SPU may be configured to provide a first electric output signal based on the processing of the first and/or second electric input signal(s). The SPU may be configured to provide a second electric output signal. The second electric output signal may be based on the processing of the first and/or second electric input signal(s). The SPU may comprise elements such as an amplifier, a compressor and/or a noise reduction system, filters, etc.

The SPU is configured to receive the input signal from the input transducer and to generate the processed signal. The processed signal, apart from being based on the input signal, may also be based on signals from other input transducers, feedback signals, etc. The processed signal is a modified input signal.

In addition to the input signal, the one or more microphone output signals may be provided to the SPU for processing the one or more microphone output signals. The signals may be processed such as to compensate for a user's hearing loss or hearing impairment. The SPU may be comprised in a housing of an in-the-ear (ITE) unit or a behind-the-ear (BTE) unit.

The adaptive feedback filter dynamically reduces acoustic feedback stemming from MIE by modelling the feedback path and subtracting its effects from the microphone signal in real time. In other words, this feedback filter removes the excess gain from the feedback path between output, i.e. the receiver, to the input of the hearing device. The acoustic feedback path is the route the sound takes from the speaker back to MIE. The adaptive feedback filter typically adapts to the residual feedback path not captured and compensated by a static filter, such as minor reinsertion differences and general changes in the feedback path. Removing the excess gain breaks the feedback loop thereby keeping the hearing device in a stable condition, in accordance with the known maximum stable gain of the hearing device. The characteristics of the adaptive feedback filter are dynamically updated to match changes in the feedback path, such as when MIE moves or environmental conditions for MIE change. The SPU, and in particular feedback filters, such as the adaptive feedback filter, continuously monitor the signals to adapt to changes, ensuring effective suppression even in dynamic environments. The adaptive feedback filter is typically implemented in addition to the static feedback filter. The adaptive filter is thus typically referred to as a fast-adaptive filter to distinguish it from the static filter which is typically slower in adapting its signal than the adaptive feedback filter. The adaptive filter continuously acts to adapt the resulting output of the receiver in the ear in response to changes in the sound received by MIE which may be caused by changes in external circumstances. Such changes could involve variations in the way the receiver is positioned, slow build-up of cerumen in the ear, change in position of the BTE housing behind the pinna, the user putting on a pair of spectacles, putting on a hat, holding something to the ear such as a hand or a telephone, leaning against a wall or a cushion, hugging a person, etc., all changing the impulse response of the acoustic path.

The adaptive filter is characterized by its filter coefficients. The filter coefficients are numerical values that define the behaviour of the adaptive feedback filter. They determine how the adaptive filter manipulates a signal at its input to produce an adapted output signal for cancelling acoustic feedback from MIE and the speaker. The coefficients represent the weights applied to the current input signal and are directly related to the filter's impulse response and define its frequency response.

The filter coefficients change in response to changes of the input signal from MIE. The input signal may change when MIE is moved only within the ear, as well as when MIE is moved drastically, such as when moved outside of the ear. The change occurs as the impulse response of the acoustic path changes and the adaptive filter is configured to dynamically follow such changes.

The filter coefficients may also include a delay in the adaptive filter. The delay is continuously obtained as a part of the filter update. The delay of the feedback path changes drastically when, e.g., the hearing device is being placed on the table or in the free field.

The signal processing unit is configured to monitor the filter coefficients. The SPU may also be configured to monitor changes in the coefficients of the adaptive feedback filter.

The SPU is further configured to determine a state of the hearing device based on the threshold and the filter coefficients. By determining the state of the hearing device, it is determined, e.g., whether the hearing device is being removed from the ear, or whether the hearing device is booting into the charger, or whether the user is placing the hearing device into the ear, or whether the user is removing the hearing device from the charger.

The state of the hearing device may be defined by the placement of MIE. For instance, when MIE is placed in the ear, the hearing device will typically operate in an active state. When MIE is outside of the ear, the hearing device would normally operate in an idle state, or in a sleep mode, or should be switched off. When MIE is enclosed by the charging cavity, the hearing device may be switched off.

The hearing device may operate in a first state, the first state being an active state of the hearing device, i.e. when the hearing device is in use and properly placed in the user's ear, in particular when MIE is placed in the ear canal, such as in the predefined position. The hearing device may operate in the first state also in cases when MIE is slightly displaced from its predefined/optimal position, while still being placed in the user's ear.

The hearing device may operate in a second state. The second state may be an idle state of the hearing device, or a sleep state, or switched off. The second state may refer to the state when the hearing device is not in use and/or when it is not placed in the user's ear nor in a cavity of a charging device. In this state, a speaker of the hearing device may need to be disabled while the SPU is typically operating normally.

The hearing device may operate in a third state. The third state may be a charging state of the hearing device, i.e. when the hearing device is placed in the charging device and thereby MIE is enclosed by the charging cavity.

The threshold may be a scalar or a vector. The threshold is typically predetermined and stored in an SPU memory. The threshold may be defined to correspond to a scenario when the hearing device, and in particular when MIE is enclosed, either by the ear canal or by the charger. The SPU may continuously perform a function that depends on the threshold and the current filter coefficients and provide an output indicator indicating the state of the hearing device. The indicator may take a plurality of values, each value corresponding to a state, e.g., 0 indicating that the state does not correspond to an assumed state, 1 indicating that the hearing device is arranged in the ear, 2 indicating that the hearing device is not enclosed by the ear/charger, 3 indicating that the hearing device is enclosed by the charger.

The threshold may be continuously calculated on the basis of the filter coefficients. For instance, the threshold may be calculated as a p-norm based on a smoothed version of the adapting feedback filter representing long term changes in the feedback path.

The threshold may be calculated by transforming the adaptive feedback filter into the frequency domain and set an individual threshold for each frequency bin. For instance, each individual threshold may be 20% lower than corresponding individual values for each frequency bin for the case when the hearing device is in the ear. This could furthermore be a frequency weighted threshold up against the feedback filter, e.g. calculated during fitting of the hearing device, from the known frequency distribution. Namely, when a feedback suppression calibration is performed, a frequency distribution of the entire feedback path can be made. The lowest points of the MIE frequency response when the hearing device is in use may indicate critical frequency areas for the feedback canceller in the feedback path. At these critical frequency areas, the hearing device may have feedback already with 0 dB gain without active feedback cancellation. Hence, when the hearing device is taken out of the ear, those frequency areas may be disturbed the most. Therefore, the threshold could be weighted and more importance could be given to those critical frequency bins. Additionally, static filters related to MIE may be used for this frequency analysis.

The threshold may be calculated on the basis of filter delay. For instance, when the delay for the largest filter coefficient changes more than, e.g., 2 samples, then the SPU determines that the hearing device is taken out of the ear.

In some implementations, the SPU may define a plurality of predetermined thresholds, such as a first predetermined threshold related to the first state, a second predetermined threshold related to the second state, a third predetermined threshold related to the thirds state, etc. The first predetermined threshold may be predefined already at the factory or may be determined during fitting of the hearing device, in case the hearing device requires special fitting for the user. The first predetermined threshold may refer to a limit that should be met in case the hearing device is in its active mode and placed in the ear of the user. If the hearing device is operating in an active mode (i.e. generating an acoustic signal for the user), the SPU may use the first predetermined threshold in determination of the state. If the hearing device is charging, the SPU may use the third predetermined threshold in determination of the state. The SPU may thus be configured to determine, in response to changes of the input signal and thus changes of the filter coefficients, whether the state, and optionally, a position of MIE, is changing with respect to an assumed state or with respect to the predefined position.

It is advantageous to determine the state of the hearing device as the knowledge on whether the hearing device is being inserted or removed to/from the user's ear or to/from its charger can be used to prevent undesired sounds generated in response to faulty operation of the feedback loop. According to the present disclosure, the determination is performed only by means of SPU and its adaptive feedback filter which already form part of the hearing device with MIE. Additionally, the computation is simple and not demanding from the computation power point of view as it only involves filter coefficients and a threshold which can be predefined or calculated on the basis of the filter coefficients.

Upon determination of the state, the signal processing unit may be configured to control the hearing device based on the determined state. The SPU may be configured to adjust settings of the hearing device based on the determined state or control the hearing device in another way. By controlling the hearing device on the basis of the determined state undesired squealing of the hearing device may be prevented, and especially when the hearing device changes its state. In particular, by controlling the hearing device on the basis of the determined state, squealing occurring during reinsertions of the hearing device with MIE into the user's ear can be prevented. Also, feedback squealing occurring when the hearing device is booting into the charger can be prevented. Furthermore, faulty adaption of an adaptive algorithm when the hearing device is removed from the ear/charger can be prevented.

The signal processing unit may be configured to determine a position change of the input transducer on the basis of the filter coefficients. For instance, the SPU may determine whether MIE changes state from being in the ear canal to being removed from the ear canal, or it can be determined when the hearing device changes state from being in the ear to booting into the charger, or when the hearing device changes state from being outside of the ear to being placed into the ear. As MIE is changing its position in the ear canal, the filter coefficients of the adaptive filter are also changing to compensate for the position change reflected in the feedback loop. The SPU monitors the filter coefficients and can be configured to compare the filter coefficients from a first time slot with filter coefficients in a second time slot. In this scenario, the threshold can take the value defined by the filter coefficients of the first time slot. If there is a discrepancy of the filter coefficients from the first time slot compared to the second time slot, the SPU may provide an indicator that MIE changed its position over time. The SPU may determine a degree of the deviation in the filter coefficients from the two time slots. If the filter coefficients of the adaptive filter suddenly undergo substantial changes this can be used as an easily detectable indication that the hearing device changed its state. If at least one filter coefficient deviates for 20% from its corresponding filter coefficient of the other time slot, the SPU may generate an indicator indicating a drastic change of MIE position, the drastic position change being, e.g., from MIE being outside of the ear to MIE being inside the ear. The position change may also be determined on the basis of the threshold and the filer coefficients. If the current position of MIE is in the ear, the threshold may be defined on the basis of filter coefficients when MIE is in the predefined position. This threshold may be precalculated during fitting of the hearing device and stored in a memory of the signal processing unit/hearing device. If the current position of MIE is in the charger, the threshold may be defined on the basis of filter coefficients when MIE is in the charger. This threshold may be precalculated upon fabrication of the hearing device and stored in the memory of the signal processing unit/hearing device. The SPU may be configured to use a threshold that corresponds to the latest state of the hearing device. By determining a position change of MIE, undesired squealing of the hearing device occurring during reinsertions of the hearing device into the user's ear can be prevented. Also, feedback squealing occurring when the hearing device is booting into the charger can be prevented. Furthermore, faulty adaption of an adaptive algorithm when the hearing device is removed from the ear/charger can be prevented. In cases when the position change is not drastic, e.g. 10-20% deviation from the threshold, the SPU may be configured to generate an indicator to the user, informing the user about the position change. For instance, if the hearing device is not properly placed in the charger, the SPU may generate a predetermined alert so that the user is aware of the improper charging.

The hearing device may comprise an output transducer configured to receive the processed signal from the SPU and output an acoustic signal. When the hearing device is in use, the acoustic signal is outputted into the user's ear, i.e. into the ear canal of the user. The output transducer may also be referred to as a speaker, receiver, or loudspeaker. The output transducer may be connected to an output of the signal processor. The receiver is essentially a digital-to-analogue converter, that converts the processed signal, which is a digital signal, from the SPU to an analogue signal, such as an acoustic signal. The receiver may be comprised in an ITE unit or in an earpiece, e.g. RIE unit or M&RIE unit. In other words, the receiver is typically configured to be placed in the user's ear when the hearing device is in use. As MIE is also placed in the user's ear during the hearing device use, the acoustic sound generated by the receiver is picked up by MIE and can be amplified inside the hearing device. To prevent such feedback, both static and adaptive feedback filter typically form part of the SPU.

In some implementations, the output transducer may be a part of a printed circuit board (PCB) of the hearing device. The output transducer may be arranged on a (PCB) of the hearing device, such as on an allocated position/area on the PCB. The output transducer may be arranged through a hole in the PCB.

In response to the determined state, the signal processing unit may be configured to suppress at least a part of the acoustic signal from the output transducer. Alternatively, or additionally, the SPU may be configured to switch off the output transducer to thereby control the hearing device to operate in a second state. Suppression of the acoustic signal may occur in cases when the SPU determines that the hearing device changed its state from being in the ear to being removed from the ear, and/or when the SPU determines a position change of MIE based on the filter coefficients, from the state when MIE is in the ear to the state when MIE is outside of the ear, or vice versa. When the SPU determines that MIE is removed from the ear, the hearing device may be set to the second operating mode, i.e. it may be set into the sleep/idle mode. It is beneficial to suppress the acoustic signal from the speaker when the hearing device is removed from the ear, as in that way generation of a feedback signal and thus any undesired acoustic signal can be prevented. Also, when the SPU determines that MIE is being placed into the ear, the SPU can suppress the acoustic signal from the receiver.

In response to the determined state, the signal processing unit may be configured to adjust hearing device settings to be in accordance with the determined state. The adjustment of the settings may comprise a gain adjustment. This allows the mitigation of the feedback without entirely suppressing the signal to the receiver. The adjustment of the settings may involve signals from a further hearing device and/or another electronic device wirelessly connected with the hearing device. In some examples, this would allow the hearing device to be steered towards a monaural performance, e.g. using the ear-to-ear link between the hearing devices.

In response to the determined state, the signal processing unit may be configured to switch off the adaptive feedback filter to thereby control the hearing device to operate in a second state. Switching off the adaptive feedback filter would occur in cases when the SPU determines that the hearing device changed its state from being in the ear to being removed from the ear, and/or when the SPU determines a position change of MIE based on the filter coefficients, from the state when MIE is in the ear to the state when MIE is outside of the ear. Alternatively, or additionally, at least some parts of the hearing device may be switched off in response to a detection that the position of MIE is changing with respect to the predefined position. The signal processing unit may be adapted to change the setting of the hearing aid to OFF in response to a detection that the position of MIE is changing with respect to the predefined position. This, e.g., would yield battery savings in case the user forgets to switch off the hearing aid upon removal, as this would then happen automatically. Alternatively, only parts of the hearing aid may be switched off and still yield a battery saving. Another adjustment of the settings could comprise involvement of signals from a further hearing aid, e.g., by activating an ear-to-ear link to the other hearing aid and providing a monaural performance. One adjustment of the settings could comprise a gain reduction upon detection of the hearing aid being removed. A gain reduction will aid in suppressing the unpleasant squeal that may occur in this process.

Similarly, in response to determination that the hearing device is in the third state, i.e. it is placed in the charger, the signal processing unit may be configured to switch off the adaptive feedback filter or to adjust the hearing device settings such that the hearing device operates in accordance with the determined state.

The adaptive feedback filter may be configured to output an adapted signal. The adapted signal can be understood as a cancellation signal, that is the inverse of the estimated feedback. This signal may be subtracted from the microphone input, i.e. the input signal to the SPU, to neutralize the feedback. The adapted signal essentially stems from the processed signal and takes the input signal into account through the processed signal.

The signal processing unit may be configured to generate the processed signal based on the input signal and the adapted signal from the adaptive feedback filter. The processed signal may also include other signals from other input transducers and their corresponding feedback systems.

The signal processing unit may comprise at least one static feedback filter. The static feedback filter may be associated with MIE. Alternatively, or additionally, the static feedback filter may be associated with another input transducer. Acoustic feedback occurs when the sound output from the hearing device through the speaker is picked up by its microphone, creating a feedback loop. As the hearing device may comprise several microphones, each microphone may have a corresponding static feedback filter. The static feedback filter is typically a pre-set, fixed filter that is programmed to suppress certain frequencies where feedback is likely to occur. These frequencies are often identified during testing of the hearing device, or, if the hearing device is a hearing aid, during the hearing aid fitting process. Unlike adaptive feedback filters, static filters do not change dynamically in real time. They are typically tuned based on the specific feedback characteristics of the hearing device. In the case of a hearing aid, the static feedback filters are typically tuned based on the user's ear acoustics during initial fitting. Static filters typically do not handle changes in feedback paths, such as changes occurring when the user moves or adjusts the hearing device.

The hearing device may be a hearing aid. The signal processing unit may also be configured to compensate for a hearing loss of the user. In particular, the hearing device may be a microphone-in-the-ear (MIE) type hearing aid and more specifically, but not exclusively a microphone-and-receiver-in-the-ear (M&RIE) type hearing aid. Generally, the BTE unit may comprise at least one input transducer, a power source and a processing unit. The term BTE hearing aid may refer to a hearing aid where the receiver, i.e. the output transducer, is comprised in the BTE unit and sound is guided to the ITE unit via a sound tube connecting the BTE and ITE units, whereas the terms RIE, RIC and M&RIE hearing aids refer to hearing aids where the receiver may be comprised in the ITE unit, which is coupled to the BTE unit via a connector cable or wire configured for transferring electric signals between the BTE and ITE units.

The hearing aid may be an In-the-Ear (ITE) hearing aid, Completely-in-Canal (CIC) hearing aid or Invisible-in-Canal (IIC) hearing aid. These hearing aids may comprise an ITE unit, wherein the ITE unit may comprise at least one input transducer, a power source, a processing unit and an output transducer. These hearing aids are typically custom-made hearing aids, meaning that the ITE unit may comprise a housing having a shell made from a hard material, such as a hard polymer or metal, or a soft material such as a rubber-like polymer, moulded to have an outer shape conforming to the shape of the specific user's ear canal.

The signal processing unit may be configured to calculate a p-norm of the filter coefficients. Calculation of the p-norm is advantageous as it is fast and easy and does not require large computing power. The p-norm is calculated by a well-known equation:

$${‖ x ‖}_{p} = {( {\sum }_{n = 0}^{N - 1} {\vert x [ n ] \vert}^{p} )}^{1 / p}$$

in which p can take any natural number from 1 to ∞, x[n] represents filter coefficients x[1], . . . , x[n], n being any natural number 1 to N. For p=1, there is 1-norm. The 1-norm is advantageous as it is the simplest of all norms and it puts an even penalty on all filter coefficients (e.g. for the peak filter coefficient it scales the output linearly, while the 2-norm scales it quadratically). The 2-norm may be used to calculate the energy of the filter itself, i.e. a representation of the energy content that the coefficients represent.

As an alternative or addition to the calculation of the p-norm, the SPU may be configured to perform a cross-correlation or frequency-content analysis of the filter coefficients. To add robustness to any solution, also to the p-norm calculation, weighting the filter coefficients and analyzing the delay of the filter can be performed. Additionally, impulse response of, e.g., adaptive filters of other input transducers may be included in a weighted sum.

When the p-norm is above threshold, the SPU determines that the hearing device is enclosed. If the hearing device is charging, then the SPU determines that the hearing device is in the third state. If the hearing device is not charging, the SPU determines that the hearing device is in the first state. The state of the hearing device can thus be calculated by a simple p-norm of the adaptive filter coefficients combined with the threshold and potential smoothing. When the p-norm is above the threshold, the SPU may be configured to control the hearing device to operate in a first state. If the latest state of the hearing device was the second state, the SPU may control the gain on the output signal to thereby prevent undesired squealing of the hearing device when placing it into the ear.

When the p-norm is below threshold, the SPU determines that the hearing device is not enclosed. If the hearing device is charging, then the SPU determines that the hearing device is not properly placed in the charger and may send information to the user about it. If the hearing device is not charging, and the p-norm is below the threshold, the SPU determines that the hearing device is in the second state. When the p-norm is below the threshold the signal processing unit may be configured to control the hearing device to operate in the second state. In some scenarios, it can be determined whether the feedback path has changed to a degree that can only be caused by a removal of the hearing device and the hearing device can be set into a sleep or idle mode. Once the p-norm is back above the threshold, the SPU determines that the hearing device is either back in use or in the charger, and the SPU may control the hearing device to operate in a normal active mode or in a charging mode.

The filter coefficients may be calculated using various methods. The method may be selected in accordance with the type of the adaptive filter implemented in the hearing device. For instance, for finite impulse response (FIR) filters, the filter coefficients may be calculated by a normalized Least Mean Square (nLMS). nLMS is a simple yet effective way of calculating the coefficients of a filter. In another example, the filter coefficients of a FIR adaptive filter may be calculated by a window method, or by a frequency sampling method, or by Recursive Least Squares (RLS), or by various optimization techniques, such as least-square optimization.

The threshold may be defined on the basis of the energy content of the adaptive feedback filter. The energy content of a filter typically refers to the total energy of its impulse response, which is calculated as the sum (or integral) of the squared magnitude of the impulse response coefficients. This threshold may be already predetermined upon production of the hearing device, or it may be determined during the fitting in case the hearing device is a hearing aid. The threshold defined on the basis of the energy content of the adaptive feedback filter as the adaptive feedback filter has a minimum energy content when MIE is outside of the ear/charger and a maximum energy content when MIE is placed in the ear/charging cavity.

The threshold may be at least 20% lower than the p-norm for the first state. The signal processing unit may be configured to determine the state of the hearing device by comparing the threshold with the p-norm of the filter coefficients. If the p-norm of the filter coefficients drops 20% of its value calculated for the hearing device in the ear/charger, then the SPU determines that MIE is not enclosed and thus the hearing device is not in the ear. Setting the threshold at 20% or more below the p-norm for the first state is an easy yet reliable value that can be used for determining whether MIE changed its position from being in the ear charger to being outside of it.

The threshold may be at least 30% lower than a filter coefficient having the maximum absolute value of all filter coefficients for the first state. The signal processing unit may be configured to determine the state of the hearing device by comparing the threshold with the absolute values of the filter coefficients. If at least one filter coefficient is larger than the threshold, the SPU determines that MIE is enclosed. If all filter coefficients, i.e. their absolute values, are below the threshold, the hearing device is outside the ear/charger.

The threshold may be defined on the basis of the filter coefficients corresponding to the first state and the filter coefficients corresponding to the second state. The threshold may be set to be between the maximum filter coefficient for the first state and the maximum filter coefficient for the second state. The threshold may be set to have a value which is between the p-norm of the filter coefficients for the first state and the p-norm of the filter coefficients for the second state. For instance, the threshold may be a mean of those two p-norms. Determining the threshold in this way requires very little computing power of the SPU.

The hearing device may comprise a power source. The power source may comprise a battery providing a first voltage. The battery may be a replaceable battery. The power source may comprise a power management unit. The power management unit may be configured to convert the first voltage into a second voltage. The battery may be a rechargeable battery. The power source may comprise a charging coil. The charging coil may be provided by the magnetic antenna. The hearing device may be configured to be charged by a charger.

When the hearing device is placed in the charger, and the hearing device is charging, the hearing device is in a third state. The threshold may also be defined on the basis of the filter coefficients corresponding to the third state.

The issue of squealing may occur when the user of the hearing device is placing the hearing device into the charger or when the user is taking the hearing device outside of the charger. If the hearing device is active, the close proximity of the speaker and microphone in the confined charger space can create a feedback loop. Namely, the sound from the speaker may loop back into the microphone, amplifying the sound repeatedly and producing the high-pitched squeal.

To prevent this behavior, the SPU may be configured to control the hearing device on the basis of current adaptive filter coefficients of the adaptive feedback filter and the threshold defined on the basis of the filter coefficients corresponding to the third state, such as by turning off the hearing device, or by deactivating the speaker. According to a second aspect, disclosed is a method of operating a hearing device comprising at least an input transducer arranged in an ear canal of a user and a signal processing unit comprising an adaptive feedback filter characterized by its filter coefficients. The method comprising the steps of providing an input signal by the input transducer, receiving the input signal by the signal processing unit, and generating a processed signal by the signal processing unit. Furthermore, the method comprises the step of, at the signal processing unit, monitoring the filter coefficients which are configured to change in response to changes of the input signal. The method comprises a step of, at the signal processing unit, determining a state of the hearing device based on the filter coefficients and a threshold. The method may comprise a step of controlling the hearing device, by the signal processing unit, based on the determined state. The SPU may thus control the setting of the hearing device to thereby prevent potential squealing that may occur during, e.g., removal of the hearing device from the user's ear and/or placement of the hearing device into the charger.

It is an advantage that based on the determination of the state of the hearing device, the hearing device can be controlled to thereby prevent generation of undesired sounds.

The hearing device may comprise a RIE unit. The RIE unit typically comprises the earpiece such as a housing, a plug connector, and an electrical wire/tube connecting the plug connector and earpiece. The earpiece may comprise an in-the-ear housing, a receiver, such as a receiver configured for being provided in an ear of a user, and an open or closed dome. The dome may support correct placement of the earpiece in the ear of the user. The RIE unit may comprise an input transducer e.g. a microphone or a receiver, an output transducer e.g. a speaker, one or more sensors, and/or other electronics. Some electronic components may be placed in the earpiece, while other electronic components may be placed in the plug connector. The receiver may be with a different strength, i.e. low power, medium power, or high power. The electrical wire/tube provides an electrical connection between electronic components provided in the earpiece of the RIE unit and electronic components provided in the BTE unit. The electrical wire/tube as well as the RIE unit itself may have different lengths.

In an embodiment, the hearing device may comprise one or more wireless communication unit(s). The one or more wireless communication unit(s) may comprise one or more wireless receiver(s), one or more wireless transmitter(s), one or more transmitter-receiver pair(s) and/or one or more transceiver(s). At least one of the one or more wireless communication unit(s) may be coupled to the one or more antenna(s). The wireless communication unit may be configured for converting a wireless signal received by at least one of the one or more antenna(s) into a second electric input signal. The hearing device may be configured for wired/wireless audio communication, e.g. enabling the user to listen to media, such as music or radio and/or enabling the user to perform phone calls.

In an embodiment, the wireless signal may originate from one or more external source(s) and/or external device(s), such as spouse microphone device(s), wireless audio transmitter(s), smart computer(s) and/or distributed microphone array(s) associated with a wireless transmitter. The wireless input signal(s) may origin from another hearing device, e.g., as part of a binaural hearing system and/or from one or more accessory device(s), such as a smartphone and/or a smart watch.

The hearing device may comprise one or more antennas for radio frequency communication. The one or more antenna(s) may be configured for operation in ISM frequency band. One of the one or more antennas may be an electric antenna. One or the one or more antennas may be a magnetic induction coil antenna. Magnetic induction, or near-field magnetic induction (NFMI), typically provides communication, including transmission of voice, audio, and data, in a range of frequencies between 2 MHz and 15 MHz. At these frequencies the electromagnetic radiation propagates through and around the human head and body without significant losses in the tissue.

The magnetic induction coil may be configured to operate at a frequency below 100 MHz, such as at below 30 MHz, such as below 15 MHz, during use. The magnetic induction coil may be configured to operate at a frequency range between 1 MHz and 100 MHz, such as between 1 MHz and 15 MHz, such as between 1 MHz and 30 MHz, such as between 5 MHz and 30 MHz, such as between 5 MHz and 15 MHz, such as between 10 MHz and 11 MHz, such as between 10.2 MHz and 11 MHz. The frequency may further include a range from 2 MHz to 30 MHz, such as from 2 MHz to 10 MHz, such as from 2 MHz to 10 MHz, such as from 5 MHz to 10 MHz, such as from 5 MHz to 7 MHz.

The electric antenna may be configured for operation at a frequency of at least 400 MHz, such as of at least 800 MHz, such as of at least 1 GHZ, such as at a frequency between 1.5 GHz and 6 GHZ, such as at a frequency between 1.5 GHZ and 3 GHz such as at a frequency of 2.4 GHz. The antenna may be optimized for operation at a frequency of between 400 MHz and 6 GHZ, such as between 400 MHz and 1 GHZ, between 800 MHz and 1 GHz, between 800 MHz and 6 GHz, between 800 MHz and 3 GHZ, etc. Thus, the electric antenna may be configured for operation in ISM frequency band. The electric antenna may be any antenna capable of operating at these frequencies, and the electric antenna may be a resonant antenna, such as monopole antenna, such as a dipole antenna, etc. The resonant antenna may have a length of λ/4±10% or any multiple thereof, being the wavelength corresponding to the emitted electromagnetic field.

The hearing device may comprise one or more wireless communications unit(s) or radios. The one or more wireless communications unit(s) are configured for wireless data communication, and in this respect interconnected with the one or more antennas for emission and reception of an electromagnetic field. Each of the one or more wireless communication units may comprise a transmitter, a receiver, a transmitter-receiver pair, such as a transceiver, and/or a radio unit. The one or more wireless communication units may be configured for communication using any protocol as known for a person skilled in the art, including Bluetooth, WLAN standards, manufacture specific protocols, such as tailored proximity antenna protocols, such as proprietary protocols, such as low-power wireless communication protocols, RF communication protocols, magnetic induction protocols, etc. The one or more wireless communication units may be configured for communication using same communication protocols, or same type of communication protocols, or the one or more wireless communication units may be configured for communication using different communication protocols.

The wireless communication unit may connect to the hearing device SPU and the antenna, for communicating with one or more external devices, such as one or more external electronic devices, including at least one smart phone, at least one tablet, at least one hearing accessory device, including at least one spouse microphone, remote control, audio testing device, etc., or, in some embodiments, with another hearing device, such as another hearing device located at another ear, typically in a binaural hearing device system.

In an embodiment, the hearing device may comprise a memory, including volatile and non-volatile forms of memory. In an embodiment, the hearing device may comprise a vent. A vent is a physical passageway such as a canal or tube primarily placed to offer pressure equalization across a housing placed in the ear such as an ITE hearing device, an ITE unit of a BTE hearing device, a CIC hearing device, a RIE hearing device, a RIC hearing device, a M&RIE hearing device or a dome tip/earmold. The vent may be a pressure vent with a small cross section area, which is preferably acoustically sealed. The vent may be an acoustic vent configured for occlusion cancellation. The vent may be an active vent enabling opening or closing of the vent during use of the hearing device. The active vent may comprise a valve.

The present disclosure relates to different aspects including the hearing device and the method described above and in the following, and corresponding device parts, each yielding one or more of the benefits and advantages described in connection with the first mentioned aspect, and each having one or more embodiments corresponding to the embodiments described in connection with the first mentioned aspect and/or disclosed in the appended claims.

### BRIEF DESCRIPTION OF THE DRAWINGS

The above and other features and advantages will become readily apparent to those skilled in the art by the following detailed description of exemplary embodiments thereof with reference to the attached drawings, in which:

FIG. 1 schematically illustrates an exemplary embodiment of the hearing device according to the present disclosure.

FIG. 2 schematically illustrates another exemplary embodiment of the hearing device according to the present disclosure.

FIG. 3 schematically illustrates yet another exemplary embodiment of the hearing device according to the present disclosure.

FIG. 4 schematically illustrates a perspective view of an ear with a hearing device according to an exemplary embodiment of the present disclosure.

FIG. 5 schematically illustrates a perspective view of a hearing device according to an exemplary embodiment of the present disclosure

FIG. 6 shows filter coefficients of an adaptive feedback filter related to MIE.

FIG. 7 shows filter coefficients of three different adaptive feedback filters related to three different microphones placed at several different positions.

FIG. 8 shows a method of operating a hearing device according to the present disclosure.

### DETAILED DESCRIPTION

Various embodiments are described hereinafter with reference to the figures. Like reference numerals refer to like elements throughout. Like elements will, thus, not be described in detail with respect to the description of each figure. It should also be noted that the figures are only intended to facilitate the description of the embodiments. They are not intended as an exhaustive description of the claimed invention or as a limitation on the scope of the claimed invention. In addition, an illustrated embodiment needs not have all the aspects or advantages shown. An aspect or an advantage described in conjunction with a particular embodiment is not necessarily limited to that embodiment and can be practiced in any other embodiments even if not so illustrated, or if not so explicitly described.

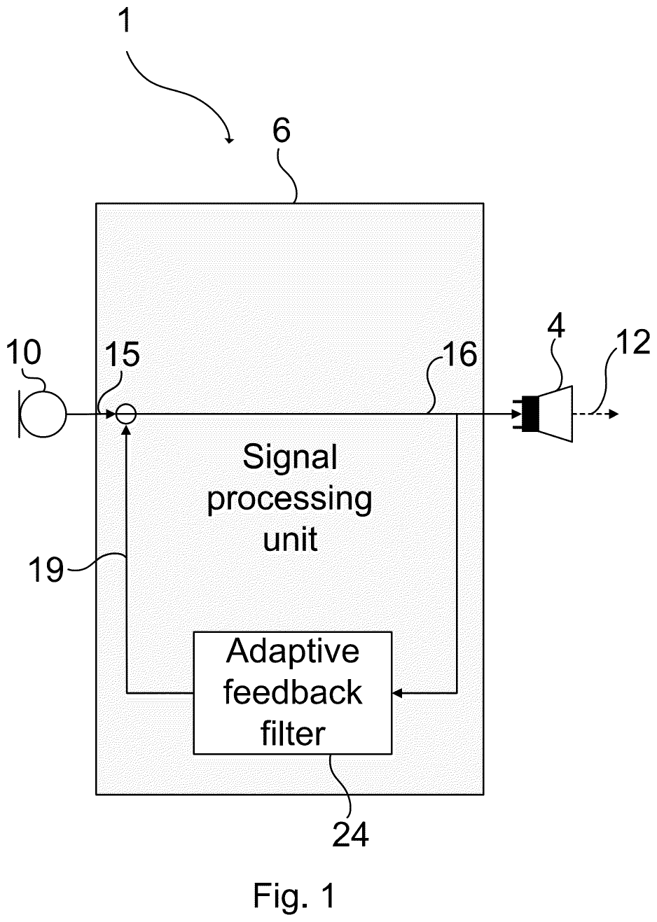

FIG. 1 schematically illustrates an exemplary embodiment of a hearing device 1 according to the present disclosure. The hearing device 1 comprises an input transducer 10 configured to be arranged in an ear canal of a user and to provide an input signal 15. The hearing device 1 further comprises a signal processing unit 6 configured to receive the input signal 15 from the input transducer 10 and to generate a processed signal 16. The signal processing unit 6 comprises an adaptive feedback filter 24. The adaptive feedback filter 24 is characterized by its filter coefficients, the filter coefficients being configured to change in response to changes of the input signal 15. The signal processing unit 6 is configured to monitor the filter coefficients and to determine a state of the hearing device 1 based on the threshold and the filter coefficients.

Typically, the adaptive feedback filter 24 outputs an adapted signal 19 and the signal processing unit 6 generates the processed signal 16 based on at least the input signal 15 and the adapted signal 19. The hearing device typically also comprises an output transducer 4 configured to receive the processed signal 16 and output an acoustic signal 12.

It is advantageous to determine the state of the hearing device as the knowledge on whether the hearing device is being inserted or removed to/from the user's ear or to/from its charger can be used to prevent undesired sounds generated in response to faulty operation of the feedback loop. According to the present disclosure, the determination is performed only by means of SPU and its adaptive feedback filter which already form part of the hearing device with MIE. Additionally, the computation is simple and not demanding from the computation power point of view as it only involves filter coefficients and a threshold which can be calculated on the basis of the filter coefficients.

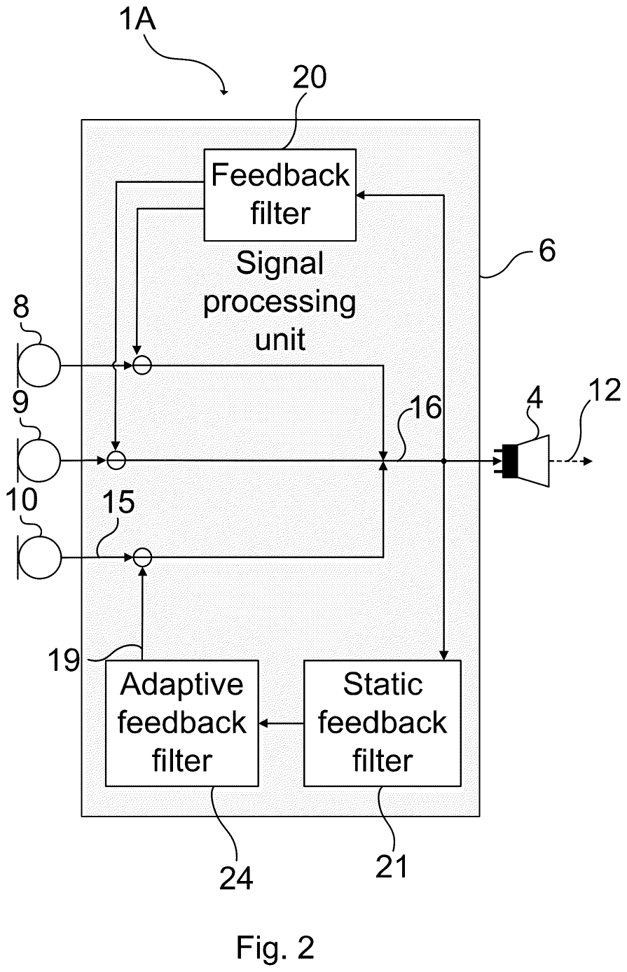

FIG. 2 schematically illustrates another exemplary embodiment of the hearing device 1A according to the present disclosure. FIG. 2 includes all features described in connection with FIG. 1 which will not be described here again. In the embodiment of FIG. 2 the signal processing unit 6 further comprises a static feedback filter 21. The static feedback filter 21 is associated with the input transducer 10. The hearing device 1A further comprises a second input transducer 8 and a third 9 input transducer. A feedback filter 20 may be associated with both the second input transducer 8 and the third input transducer 9. The hearing device 1A may comprise only one of the second 8 or the third input transducer 9. The hearing device 1A may comprise further input transducers. The signal processing unit 6 is configured to monitor the filter coefficients and to determine a state of the hearing device 1A based on the threshold and the filter coefficients of the first input transducer 10. Additionally, characteristics of the feedback filter 20 may also be taken into account when determining the state of the hearing device 1A. The signal processing unit 6 may control the hearing device 1A to operate in accordance with the determined state. For instance, in response to the determined state, the signal processing unit 6 may be configured to suppress at least a part of the acoustic signal 12 from the output transducer 4 or to switch off the output transducer 4 to thereby control the hearing device 1A to operate in accordance with the determined state.

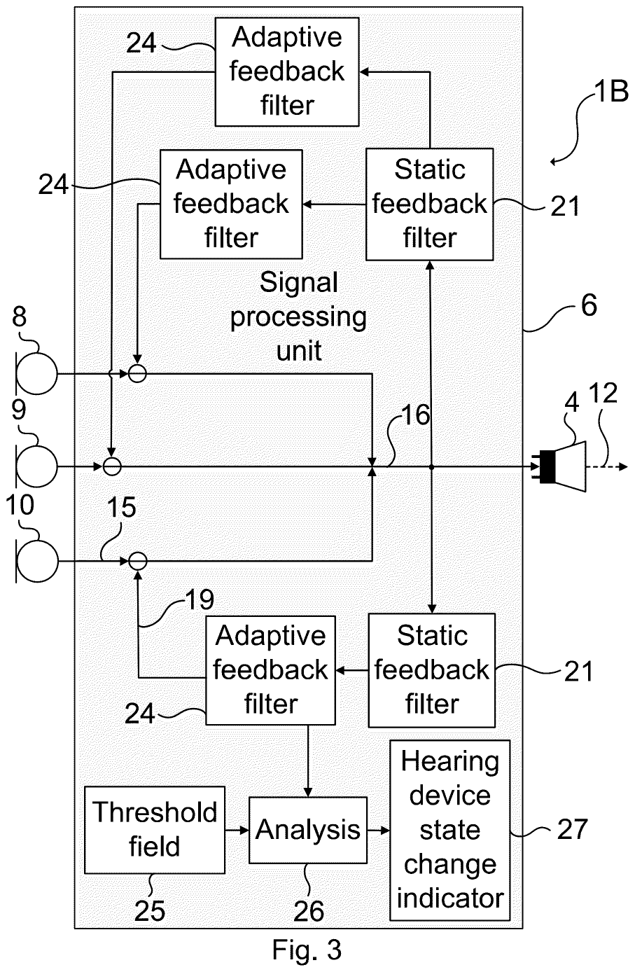

FIG. 3 schematically illustrates another exemplary embodiment of the hearing device 1B according to the present disclosure. The hearing device 1B of FIG. 3 includes all features described in connection with FIG. 2 with the difference that the feedback filter of the second and third input transducer is divided into the static feedback filter 32 and a separate adaptive feedback filters 34 and 36 for the second input transducer 8 and the third input transducer 9, respectively. The signal processing unit further comprises a threshold field 25, analysis part 26 and hearing device state change indicator 27. With those units, the SPU 6 may monitor the filter coefficients and determine a state of the hearing device 1B based on the threshold saved or determined in the threshold field 25 and the filter coefficients by a function running in the analysis part 26. The actual processing in the SPU 6 may, however, be performed differently, such as involving more sub-units.

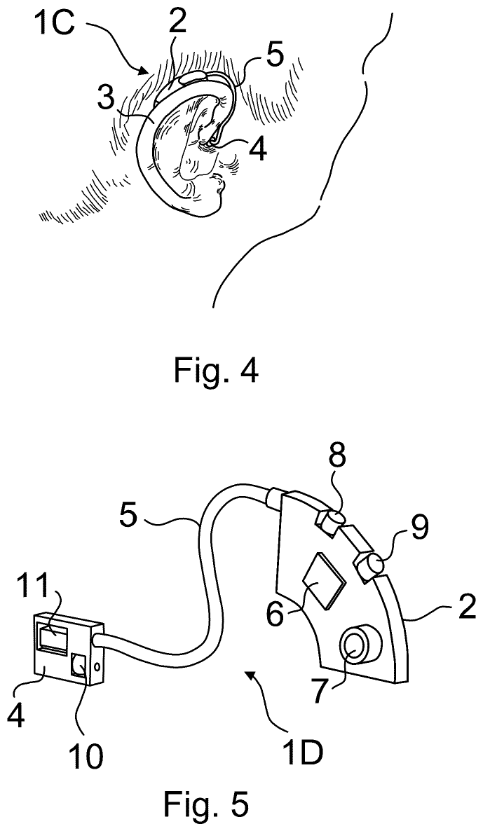

FIG. 4 schematically illustrates a perspective view of an ear 3 with a hearing device 1C according to an exemplary embodiment of the present disclosure. The hearing device 1C comprises an output transducer 4 placed in an ear canal of a user's ear 3. The hearing device 1C may be a hearing aid. The hearing aid may comprise a BTE unit 2. The BTE unit 2 may comprise a receiver 4 and the sound produced by the receiver may be guided into the ear 3 through a tube 5. In another implementation, the hearing device 1C may be a M&RIE type hearing aid and may comprise the receiver 4 also placed in the ear canal.

FIG. 5 schematically illustrates a perspective view of a hearing device 1D according to an exemplary embodiment of the present disclosure. The hearing device 1D comprises first input transducer 10, second input transducer 8 and third input transducer 9. It further comprises the signal processing unit 6 and the output transducer 4 configured to be placed in an ear canal of a user. The hearing device 1D may be a hearing aid.

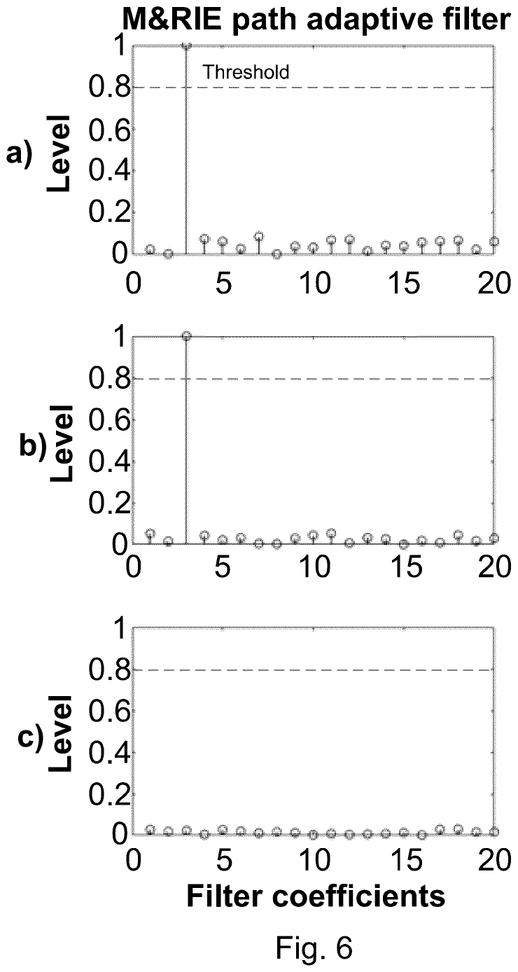

FIG. 6 shows filter coefficients of an adaptive feedback filter. The adaptive feedback filter is related to MIE.

FIG. 6a illustrates filter coefficients in a scenario when the hearing device is in use, i.e. when MIE is arranged at its predefined position, i.e. in the user's ear. In this scenario, the hearing device may operate in a first state, the first state may be an active state of the hearing device. FIG. 6a illustrates an example with 20 filter coefficients. Filter coefficient 3 have a significantly higher values than the other coefficients reflecting high energy of the filter, as MIE is enclosed by the ear canal. The peak arises because the adaptive feedback filter is modelling the leftover from what is not included in the static filter, e.g. changes occurred since the fitting at the clinic. When the hearing device is placed correctly in the ear, it would be placed more or less how it was placed at the clinic when the static filter was calculated, hence the leftover (or residual) feedback path is very small which translates into a delta filter in time domain (a ‘1’ followed by zeros). In the example illustrated in FIG. 6, there is a 2-coefficient delay. When the hearing device is taken out of the ear, then the feedback path looks very different and the residual feedback path represented by the adaptive filter has to work hard to model that, the peak disappears and the filter energy represented by the coefficients drops.

FIG. 6b illustrates filter coefficients in a scenario when the hearing device operates also in the first state, i.e. the first input transducer 10 is in the ear canal but slightly displaced from its predefined/optimal position. It can be seen that the main filter coefficients reflecting the energy of the filter remain substantially unchanged, while the change only happens in the filter coefficients carrying less energy.

FIG. 6c illustrates filter coefficients in a scenario when the hearing device is removed from the ear, i.e. the first input transducer 10 is taken out of the ear canal. It can be seen that now all filter coefficients have a very low level, indicating that overall energy of the adaptive feedback filter drastically decreased compared to the scenario when MIE was placed in the ear. In other words, as MIE is changing its position, the filter coefficients of the adaptive filter are also changing to compensate for the position change reflected in the feedback loop.

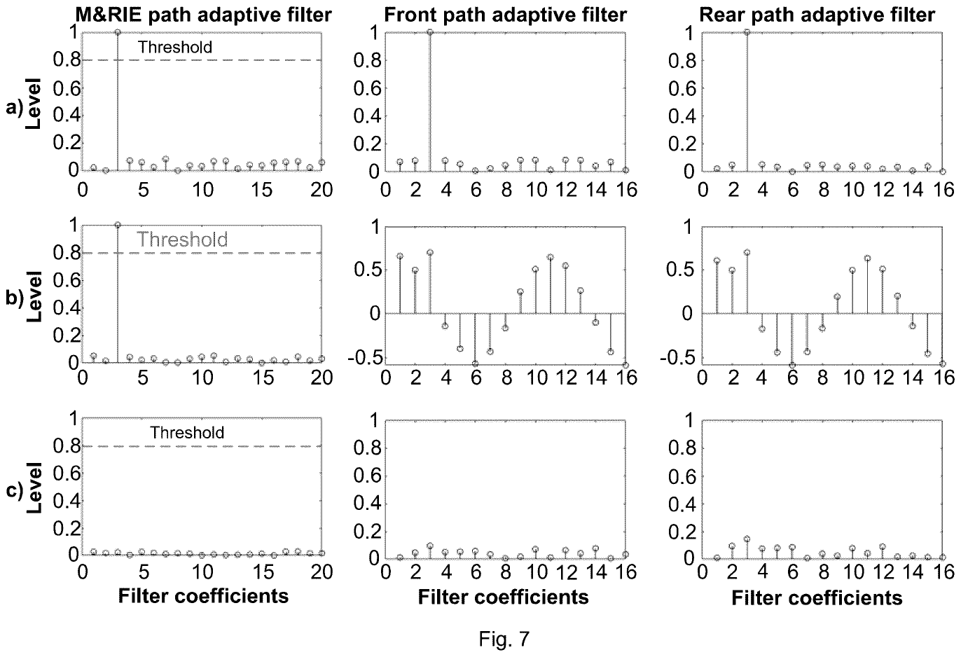

In order to determine the state of the hearing device, the SPU 6 will perform determination on the basis of a threshold and the filter coefficients. For instance, the threshold may be at least 20% lower than the value of the largest filter coefficient. The signal processing unit 6 may be configured to determine the state of the hearing device 1 by comparing the threshold with each filter coefficient separately. If all filter coefficients are below the, then the SPU 6 determines that MIE 10 is not enclosed and thus the hearing device 1 is not in the ear. FIG. 7 shows filter coefficients of three different adaptive feedback filters related to three different microphones placed at several different positions. FIG. 7a (1) shows filter coefficients of the adaptive feedback filter related to the first input transducer 10 when the hearing device 1 is in use and the first input transducer 10 is placed in its predefined position in the ear canal. FIG. 7a (2) shows filter coefficients of the adaptive feedback filter related to the second input transducer 8 when the hearing device is in use and the second input transducer 8 is placed in the hearing device 1 closer to the face of the user, but outside the user's ear canal. FIG. 7a (3) shows filter coefficients of the adaptive feedback filter related to the third input transducer 9 when the hearing device 1 is in use and the third input transducer is placed in the hearing device 1 closer to the back of the user, but outside the user's ear canal.

FIG. 7b shows a scenario when when the hearing device 1 operates also in the first state, i.e. the first input transducer 10 is in the ear canal (1) but the user is taking glasses and putting them thereby disturbing the feedback of the second 8 and third input transducers 9. It can be seen that in this scenario, the filter coefficients of the first adaptive feedback filter do not change drastically, while it is not the case with the other two adaptive filters related to the other two input transducers. FIG. 7c shows a scenario when the user takes the hearing device out of the ear. It can be seen that in this scenario, filter coefficients of all three adaptive feedback filters change drastically. Therefore, it is possible, based on the filter coefficients of the feedback filter related to MIE, determine a state change of the hearing device 1 and the SPU 6 may adapt the operation of the hearing device 1 accordingly to avoid any false operation of the hearing device 1, such as generating any undesired sounds.

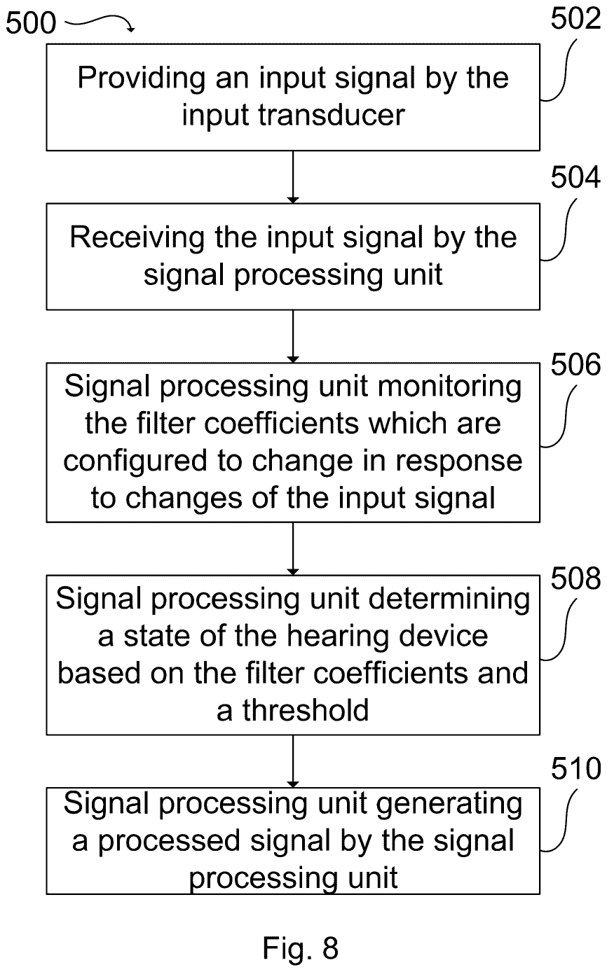

FIG. 8 shows a method 500 of operating a hearing device 1 according to the present disclosure. The hearing device may correspond to any of the hearing devices illustrated in FIGS. 1-5. The method 500 comprises the steps 502—providing an input signal by the input transducer, 504—receiving the input signal by the signal processing unit, 506—monitoring, by the signal processing unit, the filter coefficients. The filter coefficients are configured to change in response to changes of the input signal. The method further comprises the step 508 of determining a state of the hearing device based on the filter coefficients and a threshold, and the step 510 of generating a processed signal by the signal processing unit.

Although particular features have been shown and described, it will be understood that they are not intended to limit the claimed invention, and it will be made obvious to those skilled in the art that various changes and modifications may be made without departing from the scope of the claimed invention. The specification and drawings are, accordingly, to be regarded in an illustrative rather than restrictive sense. The claimed invention is intended to cover all alternatives, modifications and equivalents.

### Items

1. A hearing device comprising:
   an input transducer configured to be arranged in an ear canal of a user and to provide an input signal (15),
   a signal processing unit configured to receive the input signal (15) from the input transducer and to generate a processed signal (16),
the signal processing unit comprising
   an adaptive feedback filter characterized by its filter coefficients, the filter coefficients being configured to change in response to changes of the input signal,
wherein the signal processing unit is configured to monitor the filter coefficients and to determine a state of the hearing device based on a threshold and the filter coefficients.
2. The hearing device according to item 1, wherein the signal processing unit is configured to control the hearing device based on the determined state.
3. The hearing device according to item 1 or 2, wherein the signal processing unit is configured to determine a position change of the input transducer on the basis of the filter coefficients.
4. The hearing device according to any of the items 1-3 comprising an output transducer configured to receive the processed signal and output an acoustic signal, wherein, in response to the determined state, the signal processing unit is configured to suppress at least a part of the acoustic signal from the output transducer or to switch off the output transducer to thereby control the hearing device to operate in a second state.
5. The hearing device according to any of the items 1-3, wherein, in response to the determined state, the signal processing unit is configured to switch off the adaptive feedback filter to thereby control the hearing device to operate in a second state.
6. The hearing device according to any of the preceding items, wherein the adaptive feedback filter is configured to output an adapted signal (19).
7. The hearing device according to item 6, wherein the signal processing unit is configured to generate the processed signal (16) based on the input signal (15) and the adapted signal (19).
8. The hearing device according to any of the preceding items, wherein the signal processing unit further comprises at least one static feedback filter.
9. The hearing device according to any of the preceding items, wherein the hearing device is a hearing aid and wherein the signal processing unit is configured to compensate for a hearing loss of the user.
10. The hearing device according to any of the preceding items, wherein the signal processing unit is configured to calculate a p-norm of the filter coefficients.
11. The hearing device according to item 10, wherein
when the p-norm is above the threshold the signal processing unit is configured to control the hearing device to operate in a first state and
when the p-norm is below the threshold the signal processing unit is configured to control the hearing device to operate in a second state.
12. The hearing device according to any of the preceding items, wherein the filter coefficients are calculated by a normalized Least Mean Square, nLMS.
13. The hearing device according to any of the preceding items, wherein the threshold is defined on the basis of the energy content of the adaptive feedback filter.
14. The hearing device according to any of the preceding items, wherein the threshold is defined on the basis of the filter coefficients corresponding to a first state and the filter coefficients corresponding to a second state.
15. The hearing device according to any of the preceding items 10-14, wherein the threshold is at least 20% lower than the p-norm for the first state and wherein the signal processing unit is configured to determine the state of the hearing device by comparing the threshold with the p-norm of the filter coefficients.
16. The hearing device according to any of the preceding items, wherein the threshold is at least 30% lower than a filter coefficient having the maximum absolute value of all filter coefficients for the first state and wherein the signal processing unit is configured to determine the state of the hearing device by comparing the threshold with the absolute values of the filter coefficients.
17. The hearing device according to any of the preceding items, wherein the hearing device comprises a rechargeable battery and wherein the hearing device is configured to be charged by a charger.
18. The hearing device according to item 17, wherein the threshold is defined on the basis of the filter coefficients corresponding to a third state.
19. The hearing device according to any of the preceding items, wherein in response to the determined state, the signal processing unit is configured to adjust hearing device settings to be in accordance with the determined state.
20. A method of operating a hearing device comprising at least an input transducer arranged in an ear canal of a user and a signal processing unit comprising an adaptive feedback filter characterized by its filter coefficients, the method comprising the steps of:
   providing an input signal (15) by the input transducer,
   receiving the input signal by the signal processing unit
at the signal processing unit
   monitoring the filter coefficients which are configured to change in response to changes of the input signal
   determining a state of the hearing device based on the filter coefficients and a threshold;
   generating a processed signal (16) by the signal processing unit.

LIST OF REFERENCES

| | |
|---|---|
| 1 | Hearing device |
| 2 | Behind the ear unit |
| 3 | Ear |
| 4 | Output transducer |
| 5 | Tube |
| 6 | Signal processing unit |
| 7 | Rechargeable battery |
| 8 | Second input transducer |
| 9 | Third input transducer |
| 10 | First input transducer |
| 12 | Acoustic signal |
| 15 | Input signal |
| 16 | Processed signal |
| 17 | Input signal from second input transducer |
| 18 | Input signal from third input transducer |
| 19 | Adapted signal |
| 20 | Feedback filter |
| 21 | Static feedback filter |
| 24 | Adaptive feedback filter |
| 25 | Threshold field |
| 26 | Analysis part |
| 27 | Hearing device state change indicator |
| 500 | Method of operating a hearing device |
| 502 | Step of providing an input signal by the input transducer |
| 504 | Step of receiving the input signal by the signal processing |
| | unit |
| 506 | Step of monitoring the filter coefficients which are |
| | configured to change in response to changes of the |
| | input signal |
| 508 | Step of determining a state of the hearing device based |
| | on the filter coefficients and a threshold |
| 510 | Step of generating a processed signal by the signal |
| | processing unit |

1. A hearing device comprising:
an input transducer configured to be arranged in an ear canal of a user and to provide an input signal; and
a signal processing unit configured to generate a processed signal based on the input signal;
wherein the signal processing unit comprises an adaptive feedback filter having filter coefficients, the filter coefficients being variable in response to a change of the input signal; and
wherein the signal processing unit is configured to monitor the coefficients of the adaptive feedback filter, and to determine a state of the hearing device based on a threshold and the filter coefficients.

2. The hearing device according to claim 1, wherein the signal processing unit is configured to control the hearing device based on the determined state.

3. The hearing device according to claim 1, wherein the signal processing unit is configured to determine a position change of the input transducer based on the filter coefficients.

4. The hearing device according to claim 1, further comprising an output transducer configured to provide an acoustic signal based on the processed signal, wherein, the signal processing unit is configured to suppress at least a part of the acoustic signal, or to switch off the output transducer, in response to the determined state.

5. The hearing device according to claim 1, wherein the signal processing unit is configured to switch off the adaptive feedback filter in response to the determined state.

6. The hearing device according to claim 1, wherein the adaptive feedback filter is configured to output an adapted signal, and wherein the signal processing unit is configured to generate the processed signal based on the input signal and the adapted signal.

7. The hearing device according to claim 1, wherein the hearing device is a hearing aid, and wherein the signal processing unit is configured to compensate for a hearing loss of the user.

8. The hearing device according to claim 1, wherein the signal processing unit is configured to calculate a p-norm of the filter coefficients.

9. The hearing device according to claim 8, wherein
when the p-norm is above the threshold, the signal processing unit is configured to control the hearing device to operate in a first state, and
when the p-norm is below the threshold, the signal processing unit is configured to control the hearing device to operate in a second state.

10. The hearing device according to claim 1, wherein the signal processing unit is configured to calculate the filter coefficients based on a normalized Least Mean Square, nLMS.

11. The hearing device according to claim 1, wherein the threshold is based on an energy content of the adaptive feedback filter.

12. The hearing device according to claim 11, wherein the energy content of the adaptive feedback filter is associated with a total energy of an impulse response.

13. The hearing device according to claim 1, wherein the threshold is defined based on the filter coefficients corresponding to a first state, and the filter coefficients corresponding to a second state.

14. The hearing device according to claim 1, wherein the threshold is between a first maximum filter coefficient for the first state and a second maximum filter coefficient for the second state, and wherein the first and second maximum filter coefficients are associated with the filter coefficients.

15. The hearing device according to claim 1, wherein the threshold is at least 20% lower than a p-norm of the filter coefficients.

16. The hearing device according to claim 1, wherein the signal processing unit is configured to determine the state of the hearing device by comparing the threshold with a p-norm of the filter coefficients.

17. The hearing device according to claim 1, wherein one of the filler coefficients has a maximum absolute value, and wherein the threshold is at least 30% lower than the maximum absolute value.

18. The hearing device according to claim 1, wherein the signal processing unit is configured to determine the state of the hearing device by comparing the threshold with absolute values of the filter coefficients.

19. A method performed by a hearing device comprising an input transducer and a signal processing unit, the input transducer configured to be arranged in an ear canal of a user, the signal processing unit comprising an adaptive feedback filter, the adaptive feedback filter comprising filter coefficients, the method comprising:
providing an input signal by the input transducer;
generating a processed signal by the signal processing unit based on the input signal;
monitoring the filter coefficients of the adaptive feedback filter by the signal processing unit, wherein the filter coefficients are variable in response to a change of the input signal; and
determining a state of the hearing device based on the filter coefficients and a threshold.
